(19) United States
(12) Patent Application Publication
(10) Pub. No.: US 2010/0005085 A1
(43) Pub. Date: Jan. 7, 2010

(54) CREATING RELATIONSHIP MAPS FROM ENTERPRISE APPLICATION SYSTEM DATA

(75) Inventors: Martin Millmore, Berkshire (GB); Dinesh Arora, Cupertino, CA (US); Michael Rossi, Manhattan Beach, CA (US); Aaron Green, San Francisco, CA (US); Paul Brimble, Yelverton (GB)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/167,661

(22) Filed: Jul. 3, 2008

(51) Int. Cl. G06F 7/06; G06F 17/30

(52) U.S. Cl. 707/5; 707/3; 707/E17.014

(57) ABSTRACT

Systems and methods are provided that create a relationship map using enterprise application system (EAS) data. Relationship data is automatically collected from EAS modules. The EAS modules may be enterprise resource planning (ERP) modules. A relationship map is then generated from the collected relationship data. Thus, a representation of formal and informal working relationships among employees in an organization is built, where such relationship data was previously too onerous to capture manually. Further, this representation may be visually illustrated to a user, enabling the user to navigate among the relationships of their fellow coworkers.

### FIELD OF THE INVENTION

One embodiment is directed generally to Enterprise Application Systems (“EASs”), and in particular to the creation of relationship maps from EAS data.

### BACKGROUND INFORMATION

Enterprise Application Systems are typically integrated software applications that perform business functions such as accounting, production scheduling, customer information management, human capital management, etc. They are frequently implemented on servers and simultaneously provide services to a large number of users, typically over a computer network. These systems are in contrast to the more common single-user software applications which run on a user's own local computer and serve only one user at a time. Typically, the Enterprise Application System (“EAS”) is implemented as a group of software modules sharing a common database. Examples of an EAS include a Customer Relations Management (“CRM”) system, a Manufacturing Resource Planning (“MRP”) system, and an Enterprise Resource Planning (“ERP”) system.

Enterprise Resource Planning is an industry term for integrated, multi-module application software packages that are designed to serve and support multiple business functions. An ERP system can include software for manufacturing, order entry, accounts receivable and payable, general ledger, purchasing, warehousing, transportation and human resources. Evolving out of the manufacturing industry, ERP implies the use of packaged software rather than proprietary software written by or for one customer. ERP modules may be able to interface with an organization's own software with varying degrees of effort, and, depending on the software, ERP modules may be alterable via the vendor's proprietary tools as well as proprietary or standard programming languages.

Often it is important to find out information about an employee, such as who they work with or what kind of work they do. This information can be recorded in an ERP system, but often that information is not up to date, because it is quite onerous for a line manager or human resources professional to keep that up to date in a rapidly changing work environment.

### SUMMARY OF THE INVENTION

One embodiment is a method for creating a relationship map using enterprise application system (EAS) data. The method comprises automatically collecting relationship data from at least one EAS module and generating a relationship map from the collected relationship data.

### BRIEF DESCRIPTION OF THE DRAWINGS

FIG. 1 is a block diagram of an ERP system in accordance with an embodiment;

FIG. 2 is a block diagram of a human resources module in accordance with an embodiment;

FIG. 3 illustrates a work directory user interface; and

FIG. 4 is a flow chart illustrating a method for combining creating a relationship map using ERP data.

### DETAILED DESCRIPTION

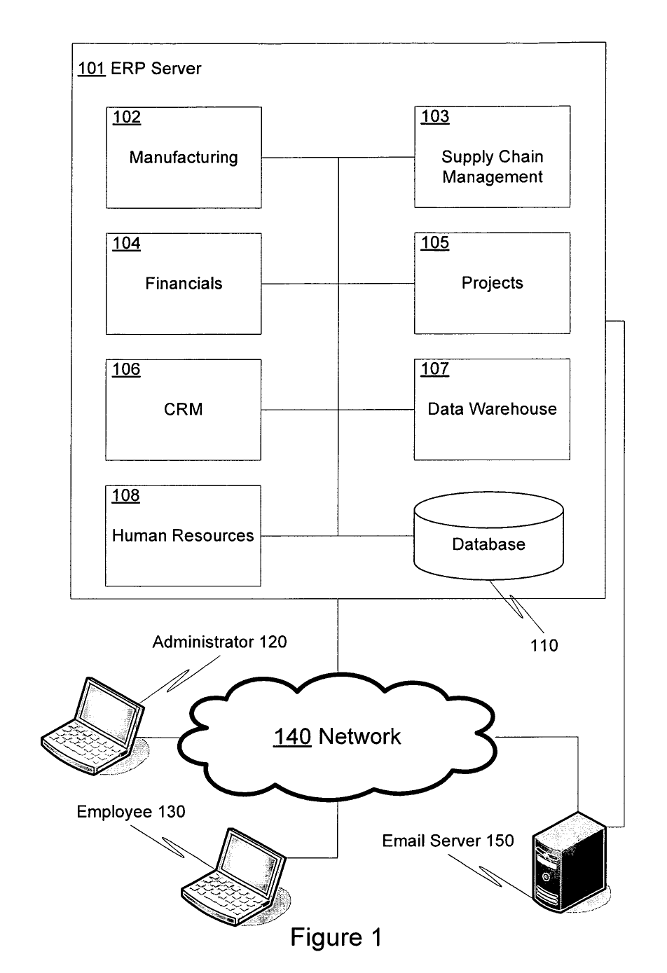

An embodiment is a method for creating a relationship map from EAS data in. In one embodiment, the EAS data and contact information are stored on an ERP server. FIG. 1 is a block diagram of an ERP server 100 in accordance with this embodiment. ERP is a software architecture that facilitates the flow of information among the different functions within an enterprise. Similarly, ERP facilitates information sharing across organizational units and geographical locations. It enables decision-makers to have an enterprise-wide view of the information they need in a timely, reliable and consistent fashion. ERP provides the backbone for an enterprise-wide information system. At the core of this enterprise software is a central database that draws data from and feeds data into modular applications that operate on a common computing platform, thus standardizing business processes and data definitions into a unified environment. With an ERP system, data needs to be entered only once. The system provides consistency and visibility or transparency across the entire enterprise. A primary benefit of ERP is easier access to reliable, integrated information. A related benefit is the elimination of redundant data and the rationalization of processes, which result in substantial cost savings.

In one embodiment, ERP server 100 is implemented as part of the Oracle® E-Business Suite. ERP server 100 includes a processor (not shown) for executing instructions and a memory (not shown) for storing an operating system and software modules executable by the processor. ERP server 100 is accessible by at least one administrator 120 and at least one employee 130 via, for example, network 140. Administrator 120, employee 130, and other entities not shown may communicate with each other using email server 150. ERP server 100 also communicates with email server 150. ERP server 100 includes a plurality of modules 102-108 and a central database 110 including data collected, utilized and reported by modules 102-108. Manufacturing module 102 collects, utilizes and reports data relating to manufacturing engineering, bills of material, scheduling, capacity, workflow management, quality control, cost management, manufacturing process, manufacturing projects, and manufacturing flow, among other aspects. Supply Chain Management module 103 collects, utilizes and reports data relating to inventory, order entry, purchasing, supply chain planning, supplier scheduling, inspection of goods, claim processing, and commission calculation, among other aspects. Financials module 104 collects, utilizes and reports data relating to general ledgers, cash management, accounts payable, accounts receivable, and assets, among other aspects. Projects module 105 collects, utilizes and reports data relating to costing, billing, and time and expenses of projects, employee activity on a project, among other aspects. Customer Relationships Management module 106 collects, utilizes and reports data relating to sales and marketing, commissions, service, customer contact, and call center support, among other aspects. Data Warehouse module 107 includes interfaces for suppliers, customers, and employees to access a data warehouse. Human Resources module 108 collects, utilizes and reports data relating to position management, performance review, applicant tracking, payroll, training, time and attendance, and benefits, among other aspects. Human Resources module 108 is described in greater detail below.

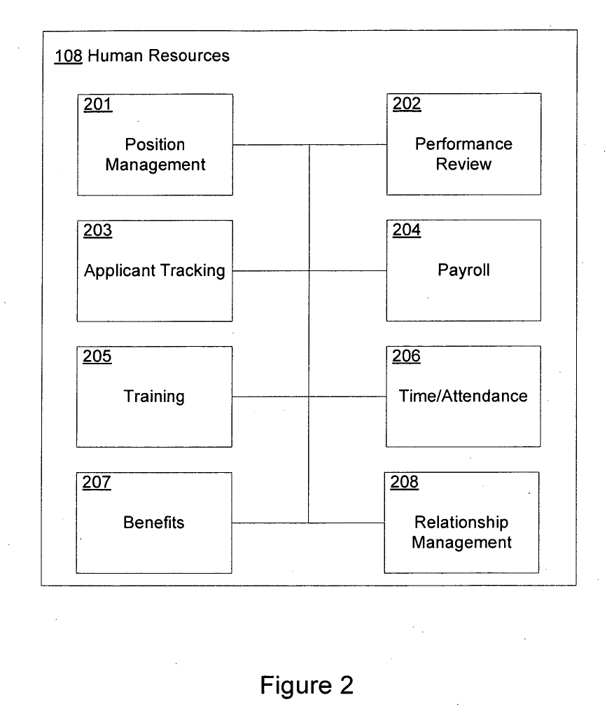

FIG. 2 is a block diagram of Human Resources module 108 in accordance with an embodiment. Human Resources module 108 includes a plurality of modules 201-207 that collect, utilize and report data relating to human resources. Position Management module 201 collects, utilizes and reports data relating to positions held by employees within the organization, and any change in those positions, among other aspects. Performance Review module 202 collects, utilizes and reports data relating to performance evaluations of employees within an organization, for example, as the evaluations relate to promotion or compensation, among other aspects. Applicant Tracking module 203 collects, utilizes and reports data relating to potential candidates for employment within the organization, among other aspects. Payroll module 204 collects, utilizes and reports data relating to employ compensation within the organization, among other aspects. Training module 205 collects, utilizes and reports data relating to continuing education courses available to employees, and which employees have completed such courses, among other aspects. Time and Attendance module 206 collects, utilizes and reports data relating to hours worked, days present, sick leave, and vacation leave for employees within the organization, among other aspects. Benefits module 207 collects, utilizes and reports data relating to employee benefits, for example, health and dental insurance, transit benefits, pension and retirement programs, and profit sharing programs, among other aspects.

Human Resources module 108 further includes Relationship Management module 208. Relationship Management 208 module collects, utilizes and reports data relating to the relationships among employees in an organization. This relationship data is acquired, either dynamically or periodically, from other ERP modules and submodules in ERP Server 101, as well as from Email Server 150. One or ordinary skill in the art will recognize that there are other possible sources for relationship data. In one embodiment, relationship data describes an instance of a relationship between two or more employees in the organization. These instances are collected and stored in database 110 for utilization by Relationship Management module 108.

For example, Relationship Management module 108 collects relationship data from Email Server 150. This relationship data may include instances of emails between two employees, or the frequency with which they exchange emails. Relationship data may further include instances where two employees are on the same distribution list, or are invited to the same meetings. Furthermore, relationship data may be asymmetric; for example, employee A emails employee B frequently, whereas employee B emails employee A hardly at all. Relationship data may further include instances where an employee is in the contact list of another.

Relationship Management module 208 also collects relationship data from other HR modules. For example, Relationship Management module 208 collects relationship data from Position Management module 201 regarding employees who work together. This relationship data for an employee may include the employee's supervisor(s) and department heads, coworkers within the employee's department, and people supervised by the employee. The relationship data may further include other employees having the same rank or title. Relationship Management module 208 may further record instances of the employee's former relationships with other employees in similar capacities.

In another example, Relationship Management module 208 collects relationship data from Training module 205. Instances of relationship data here may include employees who have completed the same training course, or who are registered to take the same training course. In yet another example, Relationship Management module 208 collects relationship data from Applicant Tracking module 201. Instances of relationship data here may include employees who started on the same day, in the same time period, or in the same department within some time period.

Relationship Management module 208 also collects relationship data from other ERP modules. For example, Relationship Management module 208 collects relationship data from CRM module 106 relating to employees who share the same customers. Relationship Management module 208 may also collect relationship data from Projects module 105 relating to employees who are on or who have worked on the same project. One of ordinary skill in the art will recognize that relationship data may be collected from a multitude of sources in addition to what is disclosed herein, both within and outside of the ERP server 101. Using the relationship data collected, Relationship Management module 208 builds a relationship map of the employees in the organization and stores this map in database 110.

In one embodiment, Relationship Management module 208 further may apply a rules set to assign weights to the relationships among employees. These weights may be based on the source of the relationship data, for example, relationship data from Position Management module 201 may carry more weight the relationship data from Training module 205. These weights may also be based on the frequency of the relationship data. For example, employees who email each other frequently will have a stronger weight in their relationship link than employees who email each other infrequently; employees who work on the same projects frequently will have a stronger weight in their relationship link than employees who work on the same projects infrequently. Like the relationships, these weights may be asymmetric in that they may be stronger in one direction than in the other. One of ordinary skill in the art will recognize that there are numerous algorithms for assigning weights, each preferred depending on their intended purpose. The administrator 120 may configure the rules set to apply weights in a manner most advantageous to the intended purpose of the relationship map.

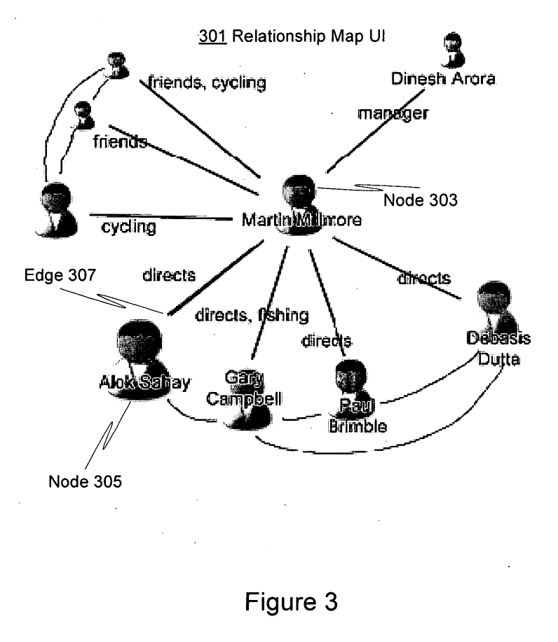

In another embodiment, Relationship Management module 208 generates and displays a visual representation of the relationship map to an employee 130. FIG. 3 illustrates an example of a relationship map user interface (UI) 301 generated by Relationship Management module 208. In the example, relationship map UI 301 represents the relationship map as a mesh of nodes, with each node representing an employee. For example, an employee of interest, Node 303, is connected to a coworker, Node 305, by Edge 307 indicating a relationship between the employees. Further, the relationship map UI 301 may illustrate the weight of relationships among employees, as calculated by Relationship Management module 208. The weights may be illustrated by numerous methods: for example, relationship map UI 301 may represent stronger relationships using thicker or thinner edges between nodes, longer or shorter edges between node, or by representing strongly related nodes as larger than lesser related nodes. Furthermore, edges among nodes such as Edge 307 may include tags indicating the type of relationship between the employees. For example, according to Edge 307, Node 303 directs Node 305.

In yet another embodiment, administrator 120 or employee 130 may manually create relationships using Relationship Management module 208. For example, employee 130 may be friends with another coworker, but this information is not apparent from ERP data. The employee manually creates a relationship instance to that coworker using Relationship Management module 208. The employee may further manually assign a weight to that relationship.

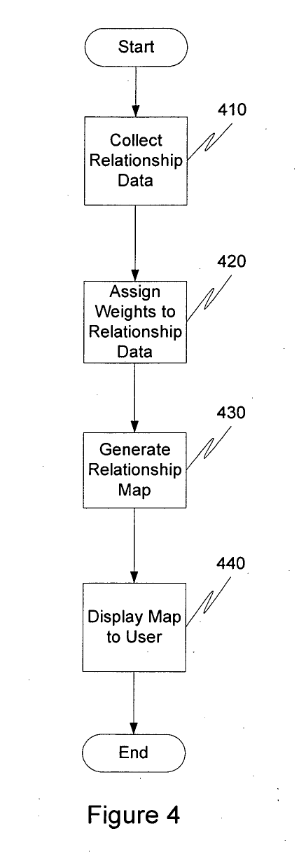

FIG. 4 illustrates a flow diagram of the functionality of ERP server 100 in accordance with an embodiment when creating relationship maps from ERP data. In one embodiment, the functionality of the flow diagram of FIG. 4 is implemented by software stored in memory and executed by a processor. In other embodiments, the functionality can be performed by hardware, or any combination of hardware and software. Relationship Management module 208 automatically collects relationship data from one of the ERP modules 102-107, and optionally from Email Server 150 (410). The Relationship Management module 208 then assigns weight to the relationship data collected based on a rules set defined by administrator 120 (420). Relationship Management module 208 then generates a map based on the relationship data collected (430). Finally, Relationship Management module 208 displays the relationship map to a user such as employee 130 (440). In an embodiment, the display map may include a visualization of the assigned weights to the relationship data in a mesh diagram.

Thus, Relationship Management module 208 automatically and collaboratively build a representation of formal and informal working relationships among employees in an organization, where such relationship data was previously too onerous to capture manually. Further, this representation may be visually illustrated to a user, enabling the user to navigate among the relationships of their fellow coworkers.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A method for creating a relationship map using enterprise application system (EAS) data, comprising:
automatically collecting relationship data from at least one EAS module; and
generating a relationship map from the collected relationship data.

2. The method of claim 1, wherein automatically collecting comprises dynamically collecting relationship data.

3. The method of claim 1, wherein automatically collecting comprises periodically collecting relationship data.

4. The method of claim 1, wherein the relationship map illustrates relationships among individuals in an organization.

5. The method of claim 1, further comprising assigning weights to relationship data.

6. The method of claim 5, wherein the weights are based on a strength of a relationship between two individuals.

7. The method of claim 6, wherein the strength of the relationship is determined from the two individuals having at least one of frequent emails between them, a shared distribution list, a shared project, a shared customer, and a shared training course.

8. The method of claim 6, wherein the strength of the relationship is determined based on a supervisory role.

9. The method of claim 1, further comprising displaying the relationship map to a user.

10. The method of claim 9, wherein the relationship map is displayed as a mesh diagram.

11. The method of claim 1, wherein the EAS data is enterprise resource planning (ERP) data and the EAS module is an ERP module.

12. The method of claim 1, further comprising collecting relationship data from an email server.

13. A computer-readable medium having instructions stored thereon that, when executed by a processor, cause the processor to create a relationship map using enterprise application system (EAS) data and that comprises:
automatically collecting relationship data from an email server and from at least one EAS module; and
generating a relationship map from the collected relationship data.

14. The computer-readable medium of claim 13, further comprising assigning weights to the relationship data.

15. The computer-readable medium of claim 13, further comprising displaying the relationship map to a user.

16. The computer-readable medium of claim 13, wherein the EAS data is enterprise resource planning (ERP) data and the EAS module is an ERP module.

17. The computer-readable medium of claim 13, further comprising collecting relationship data from an email server.

18. A system for creating a relationship map using enterprise application system (EAS) data, comprising:
an email server;
at least one EAS module; and
a relationship data module that collects relationship data from the email server and the at least one EAS module and generates a relationship map from the relationship data.

19. The system of claim 18, wherein the relationship data module assigns weights to the relationship data.

20. The system of claim 18, wherein the relationship data module displays the relationship map to a user.

21. The system of claim 18, wherein the EAS data is enterprise resource planning (ERP) data and the EAS module is an ERP module.

22. A system for creating a relationship map using enterprise application (EAS) data, comprising:
means for automatically collecting relationship data from an email server and from at least one EAS module; and
means for generating a relationship map from the collected relationship data.

23. The system of claim 20, further comprising means for assigning weights to relationship data.

24. The system of claim 20, further comprising means for displaying the relationship map to a user.

25. The system of claim 20, wherein the EAS data is enterprise resource planning (ERP) data and the EAS module is an ERP module.
